(19) United States
(12) Patent Application Publication
(10) Pub. No.: US 2021/0298383 A1
(43) Pub. Date: Sep. 30, 2021

(54) PROTECTIVE MASK

(71) Applicant: Joseph Donzelli, Wheaton, IL (US)

(72) Inventor: Joseph Donzelli, Wheaton, IL (US)

(21) Appl. No.: 17/215,719

(22) Filed: Mar. 29, 2021

Related U.S. Application Data
(60) Provisional application No. 63/000,756, filed on Mar. 27, 2020.
(60) Provisional application No. 63/039,793, filed on Jun. 16, 2020.

(51) Int. Cl. A41D 13/11; A62B 23/02

(52) U.S. Cl. CPC A41D 13/1161; A62B 23/025

(57) ABSTRACT

A protective mask, including for use in medical and diagnostic procedures, is provide. The mask has a housing having an outer surface, an inner surface, a perimeter, and a securing member to secure the mask to the user. The housing may be made of a filtering material. A mask cavity is defined between the inner surface of the housing and a face of the user wearing the mask. The housing has an aperture providing access to the mask cavity. A port is positioned about the aperture in the housing. The port has a flexible portion with one of an open inlet with a bore to receive a probe adapted to be inserted into the mask cavity and a seal to seal access to the mask cavity when no probe is inserted therein.

### CROSS-REFERENCE TO RELATED APPLICATIONS

This application claims the benefit of U.S. Provisional Patent Application No. 63/000,756 filed on Mar. 27, 2020 and U.S. Provisional Patent Application No. 63/039,793 filed Jun. 16, 2020, both of which are expressly incorporated herein by reference and made a part hereof.

### FEDERALLY SPONSORED RESEARCH OR DEVELOPMENT

Not Applicable.

### TECHNICAL FIELD

The present disclosure relates generally to a mask, and more specifically to a protective mask having ports to provide access to a mask cavity.

### BACKGROUND

Otorhinolaryngology, also called otolaryngology or otolaryngology, is a surgical subspecialty within medicine that deals with the surgical and medical management of conditions in the head and neck. Doctors who specialize in this area are called otolaryngologists or ear, nose and throat (ENT) surgeons. Patients seek treatment from an otolaryngologist for diseases of the ear, nose, throat, base of the skull, head, and neck. During certain otolaryngology patient diagnostic and therapeutic procedures, including, for example, procedures to examine a patient's airway, including the larynx and nasal passages, a flexible laryngoscope or other instrument may be inserted into the nose, throat and/or oral cavities. As a result of such procedures, contaminants may be removed or expelled from the patient's nose and throat. Such contaminants may include infectious materials. Thus, it is important to contain such contaminants. The present disclosure seeks to provide a solution to containing such contaminants during ENT procedures, and well as during other uses, such as drinking via a straw, to overcome certain of those limitations and other drawbacks of the prior art, and to provide new features not heretofore available. A full discussion of the features and advantages of the present disclosure is deferred to the following detailed description, which proceeds with reference to the accompanying drawings.

### SUMMARY

According to certain aspects of the present disclosure, the disclosed subject technology relates matter relates to a mask having accessible port(s) for accessing a mask cavity.

The disclosed technology further relates to a protective mask, including for use in medical and diagnostic procedures, comprising: a housing having an outer surface and an inner surface, the housing having a perimeter; a mask seal adjacent the perimeter of the housing to seal the housing against a user's face, a mask cavity defined between the inner surface of the housing and the user's face; a securing member to secure the mask to the user; an aperture in the housing providing access to the mask cavity; an enclosure having a first end and a second end, the first end of the enclosure connected to the housing adjacent and about the aperture, and an enclosure cavity defined between the first end and the second end of the enclosure, the enclosure cavity in fluid communication with the mask cavity through the aperture; and, a port at a second end of the enclosure to provide access to the enclosure cavity and the mask cavity, the port having a flexible portion adapted to receive a probe therethrough.

The disclosed technology further relates to a protective mask, including for use in medical and diagnostic procedures, comprising: a housing having an outer surface and an inner surface, the housing having a perimeter; a mask seal adjacent the perimeter of the housing to seal against a user's face to create a mask cavity between the inner surface of the housing and the user's face; a securing member to secure the mask to the user; an aperture in the housing providing access to the mask cavity, the aperture extending from the outer surface of the housing through to the inner surface of the housing; a port adjacent the aperture in the housing, the port having a flexible portion with an inlet to receive a medical device, the port also having a port seal adjacent the flexible portion to selectably close access to the mask cavity through the port.

The disclosed technology further relates to a protective mask, including for use in medical and diagnostic procedures, comprising: a housing having an outer surface and an inner surface, the housing having a perimeter, the housing being made of a filtering material; a mask cavity defined between the inner surface of the housing and a face of the user; a securing member to secure the mask to the user; an aperture in the housing providing access to the mask cavity, the aperture extending from the outer surface of the housing through to the inner surface of the housing; and, a port positioned about the aperture in the housing, the port having a flexible portion with one of an open inlet with a bore to receive a probe adapted to be inserted into the mask cavity and a seal to seal access to the mask cavity when no probe is inserted therein.

The disclosed technology further relates to a protective mask, wherein the housing is made of a filtering material.

The disclosed technology further relates to a protective mask, wherein the port has a rigid member to connect the port to the enclosure.

The disclosed technology further relates to a protective mask, wherein the rigid member comprises a first portion that is positioned adjacent an inner surface of the enclosure, and a second portion that is positioned adjacent an outer surface of the enclosure, and wherein the first and second portions are connected to one another on opposite sides of the enclosure to secure the port to the enclosure.

The disclosed technology further relates to a protective mask, wherein the enclosure is pleated to expand when needed.

The disclosed technology further relates to a protective mask, further comprising a seal adjacent the flexible portion, the seal providing a fluid closure for the enclosure cavity, the seal being penetrable by a probe inserted through the inlet to allow the probe to extend into the enclosure cavity, the seal closing upon removal of the probe.

The disclosed technology further relates to a protective mask, further comprising a cleaning member adjacent the port seal to clean and disinfect items removed through the port seal.

The disclosed technology further relates to a protective mask, further comprising a second port in the enclosure to provide access to the enclosure cavity and the mask cavity, the second port having a flexible portion having an inlet to receive a medical device therethrough.

The disclosed technology further relates to a protective mask, further comprising a second aperture in the housing, and an expandable reservoir secured to the housing at the second aperture, the expandable reservoir having a reservoir cavity in fluid communication with the mask cavity, the reservoir cavity of the expandable reservoir providing an increased volume for the mask cavity.

The disclosed technology further relates to a protective mask, further comprising a port in a wall of the expandable reservoir.

The disclosed technology further relates to a protective mask, wherein the mask seal comprises an air bladder.

The disclosed technology further relates to a protective mask, wherein the mask has a midline between a top of the mask and a bottom of the mask, and wherein the aperture and the port are positioned between the midline and the top of the mask.

The disclosed technology further relates to a protective mask, wherein the mask has a midline between a top of the mask and a bottom of the mask, and wherein the aperture and the port are positioned between the midline and the bottom of the mask.

The disclosed technology further relates to a protective mask, wherein the probe is a straw to allow the user to drink with the mask secured to the user's face.

The disclosed technology further relates to a protective mask, further comprising a second aperture in the housing providing access to the mask cavity, the second aperture extending from the outer surface of the housing through to the inner surface of the housing, and a second port positioned about the second aperture in the housing, the second port having a flexible portion to receive a probe therethrough.

The disclosed technology further relates to a protective mask, further comprising an opening in the mask housing and an exces reservoir sealed about the opening, the exces reservoir having a reservoir cavity to receive excess air from the user to assist in maintaining the integrity of the mask seal and mask cavity.

It is understood that other embodiments and configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

To understand the present disclosure, it will now be described by way of example, with reference to the accompanying drawings in which embodiments of the disclosures are illustrated and, together with the descriptions below are incorporated in and constitute a part of this specification, and serve to explain the principles of the disclosure. In the drawings:

FIG. 1 is a front perspective view of a medical mask having a sealed port and secured on a user according to the present disclosure.

FIG. 2 is a front view of the medical mask of FIG. 1 according to the present disclosure.

FIG. 3 is a rear view of the medical mask of FIG. 1 according to the present disclosure.

FIG. 4 is a front perspective view of another embodiment of a medical mask having an overflow reservoir and port at the end of the overflow reservoir, and secured on a user, according to the present disclosure.

FIG. 5 is a cross-sectional side view of portion of the medical mask of FIG. 4 showing a flexible laryngoscope extending through the port in the overflow reservoir from the first side of the mask through to the second side of the mask according to the present disclosure.

FIG. 6 is a front perspective view of another embodiment of a medical mask having a sealed port and an overflow reservoir, and secured on a user, according to the present disclosure.

FIG. 7 is a cross-sectional side view of portion of the medical mask of FIG. 6 according to the present disclosure.

FIG. 8 is a cross-sectional side view of portion of the medical mask of FIG. 6 showing a flexible laryngoscope extending through the sealed port in the medical mask from the first side of the mask through to the second side of the mask according to the present disclosure.

FIG. 9 is a perspective view of another embodiment of a medical mask having a sealed port for a drinking straw according to the present disclosure.

FIG. 10 is a front view of the medical mask of FIG. 9 according to the present disclosure.

FIG. 11 is a front view of the medical mask having two ports according to the present disclosure.

FIG. 12 is a front view of another embodiment of a mask having a sealed port according to the present disclosure.

FIG. 13 is a rear perspective view of the mask of FIG. 12 according to the present disclosure.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

While this disclosure is susceptible of embodiments in many different forms, there is shown in the drawings and will herein be described in detail preferred embodiments with the understanding that the present disclosure is to be considered as an exemplification of the principles of the disclosure and is not intended to limit the broad aspect of the disclosure to the embodiments illustrated. It should be noted that the features illustrated in the drawings are not necessarily drawn to scale, and features of one embodiment may be employed with other embodiments as one of ordinary skill in the relevant art would recognize, even if not explicitly stated herein. Further, descriptions of well-known components and processing techniques may be omitted so as to not unnecessarily obscure the embodiments of the present disclosure. The examples used herein are intended merely to facilitate an understanding of ways in which the present disclosure may be practiced and to further enable those of ordinary skill in the art to practice the embodiments of the present disclosure. Accordingly, the examples and embodiments herein should not be construed as limiting the scope of the present disclosure, which is defined solely by the appended claims and applicable law.

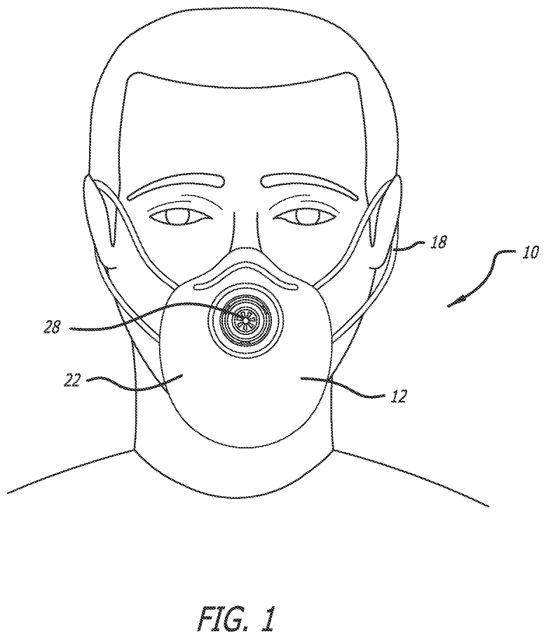

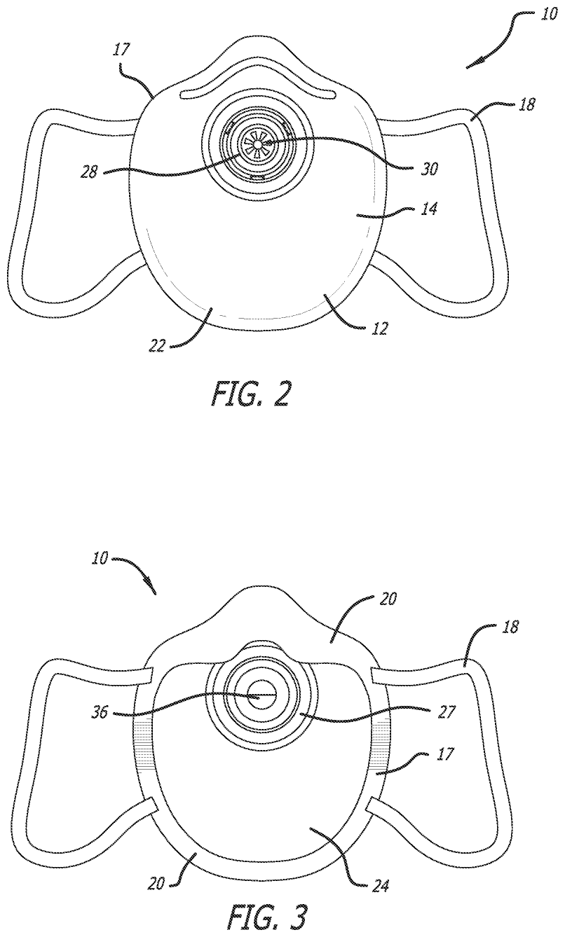

Referring now to the figures, and initially to FIGS. 1-3, there is shown a protective mask 10 according to one embodiment. Protective masks 10, such as medical masks, surgical masks and face masks are examples of personal protective equipment that are used to protect from airborne particles and from liquid contaminants. One type of protective mask 10 is a N95 respirator, such as shown in FIGS. 1-3. Such masks 10 or respirators 10 are designed to achieve a very close facial fit and very efficient filtration of airborne particles. In one embodiment, the edges of the mask 10 are designed to form a seal around the nose and mouth. Surgical N95 Respirators are commonly used in healthcare settings and are a subset of N95 Filtering Facepiece Respirators (FFRs), often referred to as N95s. The “N95” designation means that when subjected to testing, the respirator blocks at least 95 percent of very small (0.3 micron) test particles. If properly fitted, the filtration capabilities of N95 respirators exceed those of ordinary face masks. Typically, such masks 10 are “single-use,” disposable devices. Various embodiments of such masks 10 are intended for use in a health care setting. Specifically, single-use, disposable respiratory protective devices used and worn by health care personnel and patients during procedures to protect both the patient and health care personnel from the transfer of microorganisms, body fluids, and particulate material. Alternate embodiments of such masks 10 are intended for use inside or outside the health care setting.

In various implementations, the mask 10 has a mask housing 12. The mask housing 12 has a first or exterior/outer surface 22 and a second or interior/inner surface 24 opposite the exterior surface 22. The mask housing 12 also has a perimeter 17 about the edges or periphery of the mask housing 12. The mask housing 12 may also have a window, not shown, to allow for viewing through the window without telescopes.

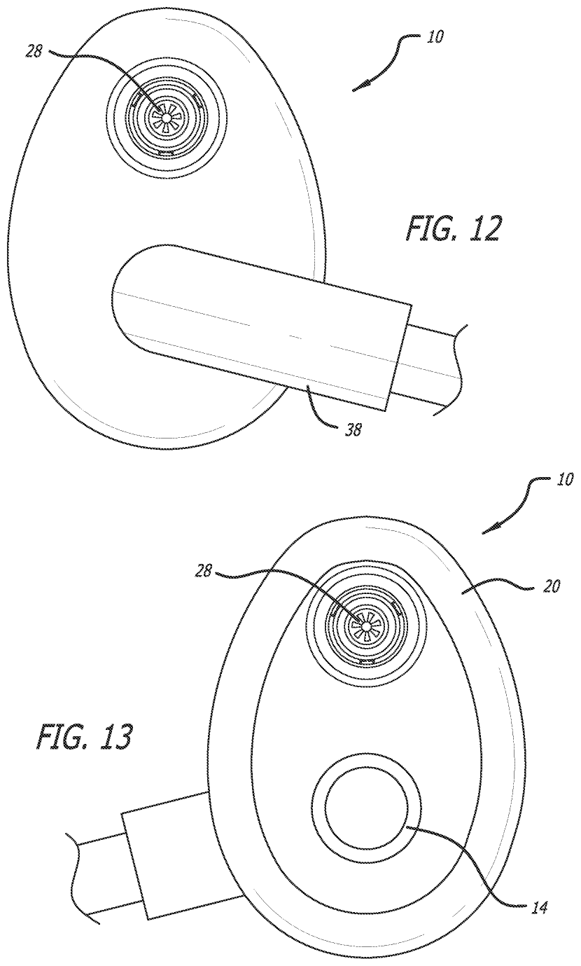

The mask housing 12 preferably has a filter 14. The filter 14 allows the user to breathe while filtering out airborne particles and liquid from escaping from the environment between the mask 10 and the user. In one embodiment, the filter 14 of the mask 10 may be integral with the mask housing 12, such as show in the embodiments of FIGS. 1-11. In such an embodiment, the housing 12 may be made of the filtering material 14. In an alternate embodiment, such as shown in FIGS. 12 and 13, the filter 14 is a separate component that is separate from but operably connected to the mask housing 12 through which the user breathes to receive air from outside the mask 10 and to filter air and material from the user. The filter 14 may be made of a filtering material 14, including but not limited to a single ply material 14. In another embodiment the filter 14 may be made of a double ply material 14 (two layers), and in yet another embodiment the filter 14 may be made of a three-ply material 14 (three layers). In one example the three-ply material 14 may be made up from a melt-blown material placed between non-woven fabric. The melt-blown material may operate to stop or limit microbes from entering or exiting the mask 10. The filter 14 may be disposable and replaceable.

Some mask housings 12, not shown, feature pleats or folds. Pleats are used to allow the user to expand the mask housing 12 such that it covers the area from the nose to the chin. In alternate embodiments, such as shown in FIGS. 1-11, the mask housing 12 is semi-rigid. In yet alternate embodiments, such as shown in FIGS. 12 and 13, the mask housing 12 may be rigid.

There are several different ways to secure the mask 10 to the user. In one embodiment, a securing member 18 or securing device 18 is used to secure the mask 10 to the user. In one embodiment the securing member is an ear loop 18. The ear loop 8 may be a string-like material that is attached to the mask housing 12 and placed behind the ears of the user. Another way to secure the mask 10 is with the use of a tie-on mechanism (not shown), which consists of straps that are tied behind the head of the user, or alternately elastic members that go around the head of the user. The straps may be adjustable for comfort and fit. Yet another way to secure the mask 10 is with a headband (not shown), which may be an elastic strap that is secured behind the head of the user.

In one embodiment, the mask 10 preferably also includes a mask seal 20. In a preferred embodiment, the mask seal 20 is adjacent the perimeter 17 of the mask housing 12. Additionally, in one embodiment the mask seal 20 is fixedly secured to the mask housing 12. Further, in one embodiment, the mask seal 20 is provided adjacent the interior surface 22 of the mask housing 12, however, the mask seal 20 may be located in alternate locations. The mask seal 20 is used to seal the mask housing 12 against a user's face. A mask cavity 19 is defined between the inner surface 24 of the housing 12 and the user's face, with the nose and mouth of the user within the mask cavity 19. The mask seal 20 may be any material that can engage the user's face to create a seal thereto between the user and the mask 10. For example, the mask seal 20 may be a gasket, an adhesive, a tape, a rubber or rubber-like material or strip, a silicon material, a bladder, a baffle, etc. In an alternate embodiment, however, the mask 10 may not incorporate a mask seal 20, but the mask cavity 19 will still be defined between the inner surface 24 of the housing 12 and the user's face.

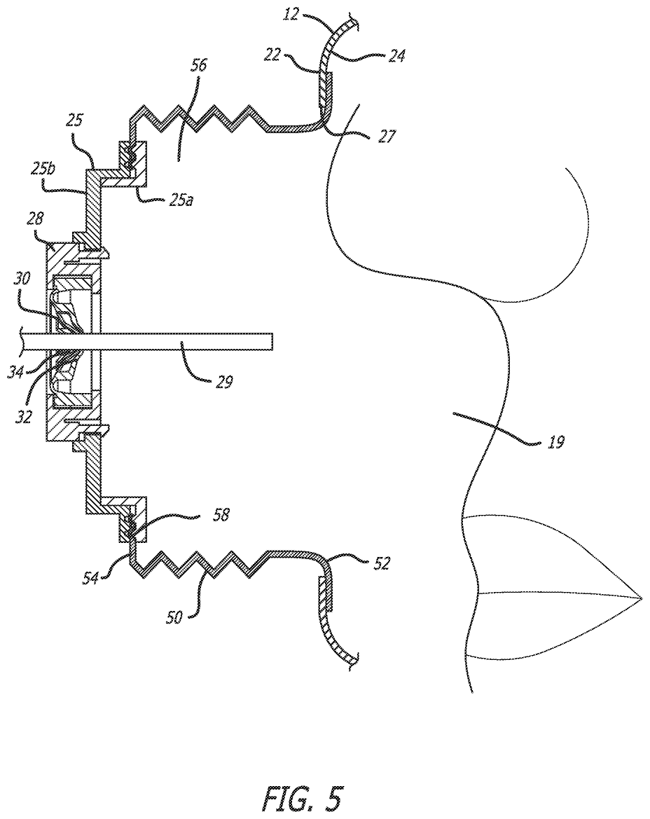

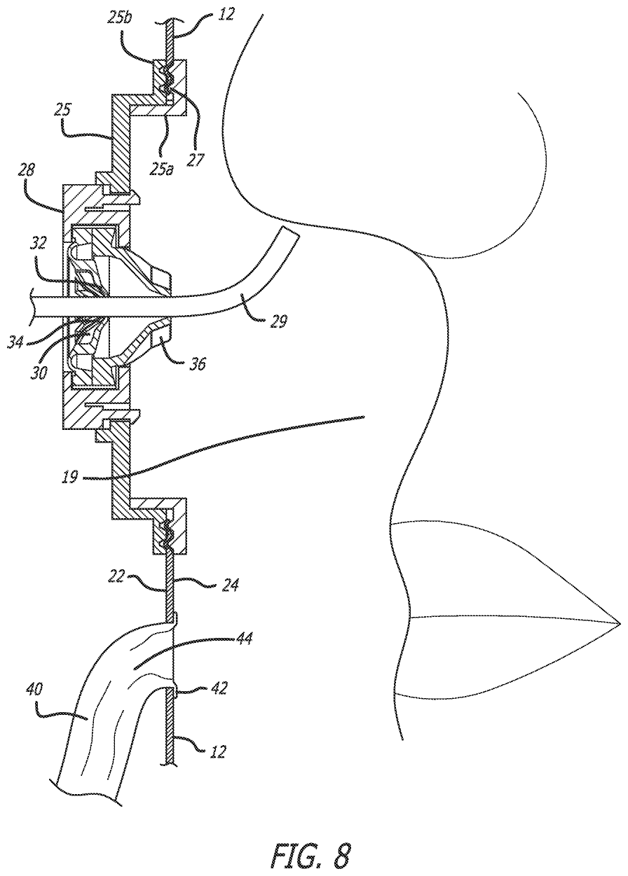

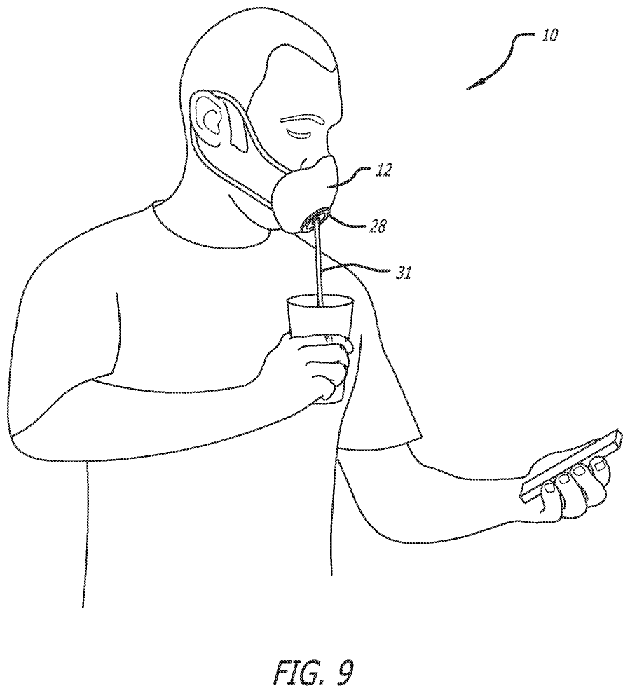

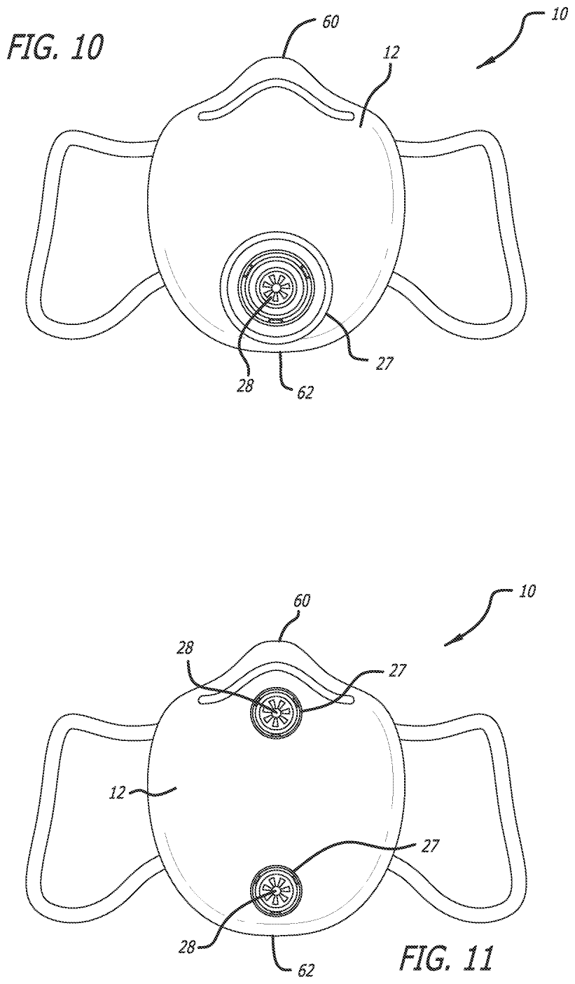

In one embodiment, for example, the user of the mask 10 is a patient during a otolaryngology patient diagnostic and/or therapeutic procedure. As such, various medical or surgical devices 29 may need to be used by a physician or other healthcare worker on the user wearing the mask 10, such as, for example, to examine or perform a procedure on a patient's nose, throat, or other oral cavity, including the larynx and nasal passages. See FIGS. 5 and 8. In another embodiment, as shown in FIGS. 9 and 10, the user is a person drinking through a straw 31 while wearing the mask 10. Accordingly, to allow a surgical device 29, or multiple surgical devices 29, or a straw 31 to pass into the mask cavity 19, in various embodiments the housing 12 has one or more apertures 27 providing access to the mask cavity 19. Preferably, the apertures 27 extend from the outer surface 22 of the housing 12 through to the inner surface 24 of the housing 12.

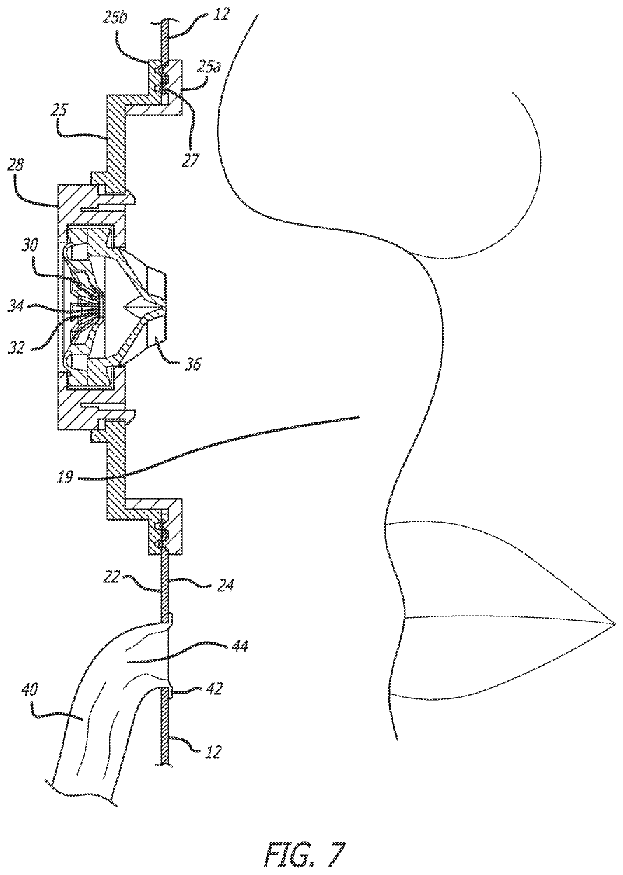

In various embodiments, the mask 10 includes at least one port 28. Each port 28 is preferably positioned about an aperture 27 in the housing 12. Additionally, the port 28 is preferably connected to the housing 12 to be secured to the mask 10. In one embodiment, the port 28 has a flexible portion 30 with one of an inlet 32 with a bore 34 to receive an item adapted to be inserted into the mask cavity 19 (see FIG. 5) or a seal 36 to seal access to the mask cavity 19 when no item is inserted therein (see FIG. 3). In an alternate embodiment as shown in FIGS. 7 and 8, the port 28 has a flexible portion 30 with both an inlet 32 and a seal 36 adjacent the flexible portion 30 to selectably close access to the mask cavity 19 through the port 28 (i.e., when no item is inserted through the seal 36). Typically the item inserted through flexible portion 30 of port 28 is a medical device 29 or a straw 31. If an inlet 32 is provided, a temporary cap, sticker, etc. may be used to seal the inlet 32 prior to or after use.

Thus, in one embodiment of the mask 10, as shown in FIG. 5, this port 28 is only sealed upon insertion of a device into the inlet 32 of the flexible portion 30 of the port 28. Preferably, the seal is formed between a perimeter of the bore 34 of the inlet 32 and the outer surface of the device therein. To create a seal with the item passing through the inlet 32 it is preferred that the outer diameter of the item that is being inserted into the inlet 32 has a larger diameter than the diameter of the bore 34 of the inlet 32. When a device is not provided within the inlet 32, such as prior to insertion of the device or following removal of the device, the inlet 32 of this type of port 28 is unsealed. However, it is understood that in an alternate embodiment a seal is not formed between the perimeter of the bore 34 of the inlet 32 and the outer surface of the device therein if the bore 34 diameter is larger than the outer diameter of the device inserted therein.

One type of seal 36 is a one-way valve, such as a duck-bill seal, or other types of valves/seals 36. Preferably, the seal 36 provides a fluid closure for the mask cavity 19. The valves 36 may be provided in addition to the inlet 32 or in place of the inlet 32. The seal 36 is penetrable by a probe inserted through the seal 36 to allow the probe to extend into the mask cavity 19. The seal 36 is closed when a device is not inserted therethrough, and further it closes upon removal of the device. Put another way, the seal 36 is closed or sealed prior to insertion of any device inserted therein and then automatically seals around the device being inserted therethrough to maintain the integrity of the mask cavity 19, and further automatically closes itself during retraction and removal of the device from the seal 36 to prevent contaminants or other material, air, etc., within the sealed mask cavity 19, to escape therefrom. As such, in a preferred embodiment the integrity of the mask cavity 19 between the patient and the inside of the mask 10 can be maintained sealed at all times. Additionally, in a preferred embodiment, a self-contained cleaning member, not shown, such as, for example, an alcohol swab or other cleaning device, which may also disinfect, may be provided at an exit of the port 28 to clean and/or disinfect the device that was inserted through the port 28. The self-contained cleaning device could be placed in series with a seal and valve to complete the cleaning process of the instrument being removed.

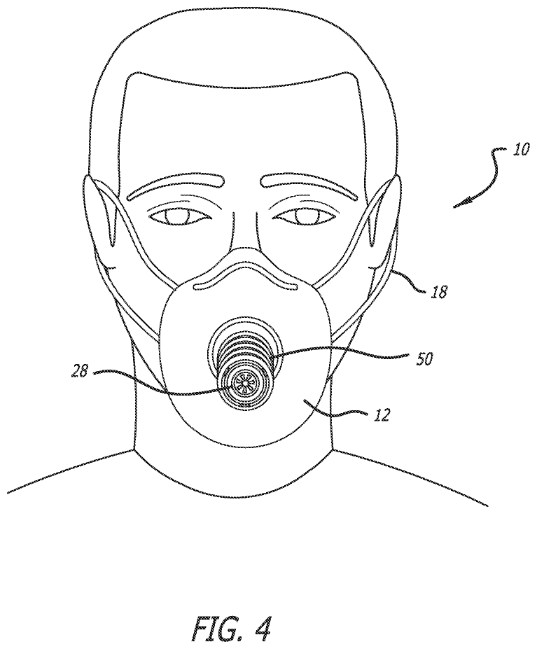

In one embodiment as shown in FIGS. 7 and 8, the port 28 has a two-part rigid member 25 to assist in connecting the port 28 to the housing 12. In the embodiment of FIGS. 4 and 5, the rigid member 25 is secured to the enclosure 50 that is described herein. In one embodiment the two-part rigid member 25 comprises a first portion 25a adjacent the inner surface 24 of the housing 12, and a second portion 25b adjacent the outer surface 22 of the housing 12. The first and second portions 25a, 25b are connected to one another on opposite sides of the housing 12 to secure the port 28 to the housing 12. In one embodiment, the flexible portion 30 of the port 28 is connected to the rigid member 25.

In various embodiments of the mask 10 multiple ports 28 are provided in the housing 12, see for example, FIG. 11. While FIG. 11 illustrates ports 28 toward the top and bottom of the mask 10, it is understood that multiple ports 28 may be provided in alternate locations on the housing 12. For example, for many medical procedures it would be beneficial to have ports 28 side-by-side toward the top of the housing 12. The ports 28 allow a medical device 29, such as a flexible or rigid laryngoscope or other instrument, or a straw 31, to be inserted through the mask housing 12 and into the mask cavity 19 between the mask 10 and the user for use on/by the user, and further to be removed therefrom, to generally prevent contaminants or other material, air, etc., within the sealed mask cavity from escaping therefrom. When multiple ports 28 are provided, one port 28 may be provided to allow a flexible laryngoscope to pass therethrough, another port 28 may be provided to allow a rigid medical device, such as a sinus seeker, sickle knife, forceps, suction, irrigation, etc. to pass therethrough, and yet another port 28 may be provided to allow oxygen to be provided to the user/patient. In one embodiment, the mask 10 is non-powered, however, in alternate embodiments power can be applied to create a negative airflow environment.

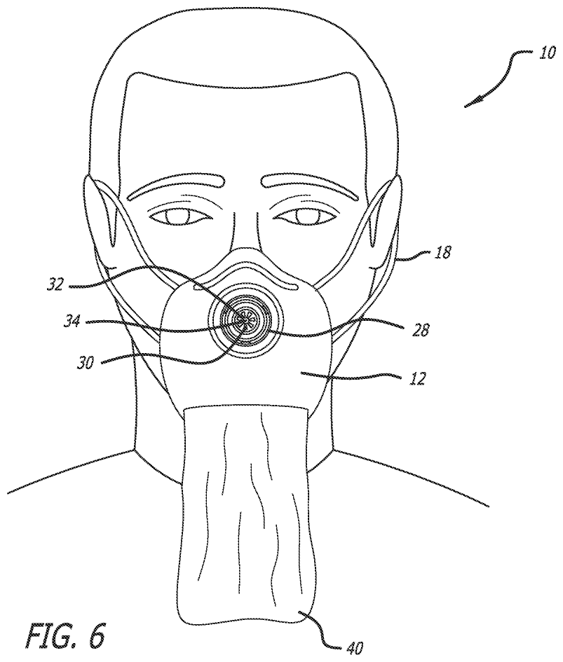

During a diagnostic or surgical procedure, the patient wearing the mask 10 may need to cough, sneeze or otherwise rapidly eject sputum, spittle, mucus, saliva or some other expectorate or bodily fluid from the mouth or nose. To prevent a rapid and/or forceful ejection from breaking the mask seal between the mask 10 and the user, in one embodiment as shown in FIGS. 6-8, the mask 10 may have an excess reservoir 40, such as an automatically enlarging excess bladder 40 that has a reservoir cavity 44 that is in fluid communication with the mask cavity 19 to provide an increased volume for the mask cavity 19. An opening 42 or aperture 42 in the mask housing 12 is provided and the excess reservoir 40 may be sealed to the mask housing 12 about the opening/aperture 42. Any excess air, liquid, bodily fluid or other contaminant may be received in the reservoir cavity 44 of the excess reservoir 40 to assist in maintaining the integrity of the mask seal 20 and mask cavity 19. In an alternate embodiment, not shown, the expandable reservoir 40 may have an accessible port 28 in the wall 48 of the reservoir 40.

In an alternate embodiment, as shown in FIGS. 4 and 5, an enclosure 50 is provided. The enclosure 50 has a first end 52 and a second end 54, and an enclosure cavity 56 defined between the first end 52 and the second end 54 of the enclosure 50. The first end 52 of the enclosure 50 is connected to the housing 12 adjacent one of the apertures 27 in the housing 12 that provides access to the mask cavity 19. Thus, the enclosure cavity 56 is in fluid communication with the mask cavity 19 through the aperture 27. The enclosure 50 may be pleated to be expandable, or other allows for expandability.

As shown in FIGS. 4 and 5, in one embodiment the enclosure 50 has an aperture 58 at the second end 54 thereof, and a port 28 at the aperture 58 to provide access to the enclosure cavity 56 and thus the mask cavity 19. As with the embodiments described above, the port 28 may have a flexible portion 30 with one of an inlet 32 with a bore 34 to receive an item adapted to be inserted into the mask cavity 19 through the enclosure cavity 56 (see FIG. 5) or a seal 36 to seal access to the mask cavity 19 when no item is inserted therein (see FIG. 3), or both. Additionally, while not show in the embodiment of FIGS. 4 and 5, the enclosure 50 may have multiple ports 28 to allow for different medical devices to be inserted into different ports 28 for use during a medical procedure. Thus, in one embodiment, a second port 28 and possible a third port 28 or other ports may be provided in the enclosure 50 to provide access to the enclosure cavity 56 and the mask cavity 19. Each of the additional ports typically have a flexible portion 30 to receive a medical device therethrough. In one example, a doctor performing a medical procedure may use the enclosure cavity 56 to place material removed from the patient. As such, the doctor may insert a device through the port 28 in the enclosure 50, use the device to remove material from the patient such as in the patients nasal cavity, and place the removed material in the enclosure cavity 56 for the remainder of the procedure to maintain the integrity of the sealed reservoir cavity 56 and mask cavity 19 and to prevent contaminants or other material, air, etc., within the sealed reservoir cavity 56 and mask cavity 19 from escaping therefrom.

Referring to the embodiment of FIGS. 7-9, the mask seal 20 may be an air bladder 20 that can be adjusted via the bladder port 36. Additionally, the filter 14 may be operably connected to the mask 10 via a filter tube 38. In one example, the mask 10 may be a mask used in connection with providing anesthesia to a patient.

Referring again to the figures, the mask 10 has an imaginary midline between a top 60 of the mask 10 and a bottom 62 of the mask 10. In one embodiment, as shown in FIG. 1, the aperture 27 and the associated port 28 are positioned between the midline and the top 60 of the mask 10. In an alternate embodiment, as shown in FIGS. 9 and 10, the aperture 27 and associated port 28 are positioned between the midline and the bottom 62 of the mask. This embodiment is preferred when the port 28 is used to provide access to the mask cavity 19 for a straw 31 that the user drinks from so that the user can drink with the mask 10 secured to the user's face. It is understood, however, that that mask 10 may have a second aperture 27 in the housing 12 providing access to the mask cavity 19, the second aperture 27 extending from the outer surface 22 of the housing 12 through to the inner surface 24 of the housing 12. And a second port 28 may be positioned about the second aperture 27 in the housing 28. The second aperture 27 and second port 28 may be positioned above the midline or below the midline.

Numerous modifications to the present disclosure will be apparent to those skilled in the art in view of the foregoing description. Preferred embodiments of this disclosure are described herein, including the best mode known to the inventors for carrying out the disclosure. It should be understood that the illustrated embodiments are exemplary only, and should not be taken as limiting the scope of the disclosure.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. Additionally, the terms “first,” “second,” “third,” and “fourth” as used herein are intended for illustrative purposes only and do not limit the embodiments in any way. Further, the term “plurality” as used herein indicates any number greater than one, either disjunctively or conjunctively, as necessary, up to an infinite number. Additionally, the term “having” as used herein in both the disclosure and claims, is utilized in an open-ended manner.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind without significantly departing from the spirit of the invention and the scope of protection is only limited by the scope of the accompanying Claims.

Further, the claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A protective mask, including for use in medical and diagnostic procedures, comprising:
a housing having an outer surface and an inner surface, the housing having a perimeter;
a mask seal adjacent the perimeter of the housing to seal the housing against a user's face, a mask cavity defined between the inner surface of the housing and the user's face;
a securing member to secure the mask to the user;
an aperture in the housing providing access to the mask cavity;
an enclosure having a first end and a second end, the first end of the enclosure connected to the housing adjacent and about the aperture, and an enclosure cavity defined between the first end and the second end of the enclosure, the enclosure cavity in fluid communication with the mask cavity through the aperture; and,
a port at a second end of the enclosure to provide access to the enclosure cavity and the mask cavity, the port having a flexible portion adapted to receive a probe therethrough.

2. The mask of claim 1, wherein the port has a rigid member to connect the port to the enclosure.

3. The mask of claim 2, wherein the rigid member comprises a first portion that is positioned adjacent an inner surface of the enclosure, and a second portion that is positioned adjacent an outer surface of the enclosure, and wherein the first and second portions are connected to one another on opposite sides of the enclosure to secure the port to the enclosure.

4. The mask of claim 1, wherein the enclosure is pleated to expand when needed.

5. The mask of claim 1, further comprising a seal adjacent the flexible portion, the seal providing a fluid closure for the enclosure cavity, the seal being penetrable by a probe inserted through the inlet to allow the probe to extend into the enclosure cavity, the seal closing upon removal of the probe.

6. The mask of claim 1, further comprising a second port in the enclosure to provide access to the enclosure cavity and the mask cavity, the second port having a flexible portion having an inlet to receive a medical device therethrough.

7. A protective mask, including for use in medical and diagnostic procedures, comprising:
a housing having an outer surface and an inner surface, the housing having a perimeter;
a mask seal adjacent the perimeter of the housing to seal against a user's face to create a mask cavity between the inner surface of the housing and the user's face;
a securing member to secure the mask to the user;
an aperture in the housing providing access to the mask cavity, the aperture extending from the outer surface of the housing through to the inner surface of the housing;
a port adjacent the aperture in the housing, the port having a flexible portion with an inlet to receive a medical device, the port also having a port seal adjacent the flexible portion to selectably close access to the mask cavity through the port.

8. The mask of claim 7, wherein the housing is made of a filtering material.

9. The mask of claim 7, wherein the mask has a midline between a top of the mask and a bottom of the mask, and wherein the port is positioned between the midline and the top of the mask.

10. The mask of claim 7, further comprising a second aperture in the housing, and an expandable reservoir secured to the housing at the second aperture, the expandable reservoir having a reservoir cavity in fluid communication with the mask cavity, the reservoir cavity of the expandable reservoir providing an increased volume for the mask cavity.

11. The mask of claim 10, further comprising a port in a wall of the expandable reservoir.

12. The mask of claim 7, wherein the mask seal comprises an air bladder.

13. The mask of claim 7, further comprising a cleaning member adjacent the port seal to clean and disinfect items removed through the port seal.

14. A protective mask, including for use in medical and diagnostic procedures, comprising:
a housing having an outer surface and an inner surface, the housing having a perimeter, the housing being made of a filtering material;
a mask cavity defined between the inner surface of the housing and a face of the user;
a securing member to secure the mask to the user;
an aperture in the housing providing access to the mask cavity, the aperture extending from the outer surface of the housing through to the inner surface of the housing; and,
a port positioned about the aperture in the housing, the port having a flexible portion with one of an open inlet with a bore to receive a probe adapted to be inserted into the mask cavity and a seal to seal access to the mask cavity when no probe is inserted therein.

15. The protective mask of claim 14, further comprising a mask seal adjacent the perimeter of the housing to seal against a user's face to create a mask cavity between the inner surface of the housing and the user's face.

16. The protective mask of claim 14, wherein the mask has a midline between a top of the mask and a bottom of the mask, and wherein the aperture and the port are positioned between the midline and the top of the mask.

17. The protective mask of claim 14, further comprising a second aperture in the housing providing access to the mask cavity, the second aperture extending from the outer surface of the housing through to the inner surface of the housing, and a second port positioned about the second aperture in the housing, the second port having a flexible portion to receive a probe therethrough.

18. The protective mask of claim 14, wherein the mask has a midline between a top of the mask and a bottom of the mask, and wherein the aperture and the port are positioned between the midline and the bottom of the mask.

19. The protective mask of claim 18, wherein the probe is a straw to allow the user to drink with the mask secured to the user's face.

20. The protective mask of claim 14, wherein the port also has a port seal adjacent the flexible portion to selectably close access to the mask cavity through the port.

21. The protective mask of claim 14, further comprising an opening in the mask housing and an excess reservoir sealed about the opening, the excess reservoir having a reservoir cavity to receive excess air from the user to assist in maintaining the integrity of the mask seal and mask cavity.
